(19) United States
(12) Patent Application Publication
(10) Pub. No.: US 2016/0191804 A1
(43) Pub. Date: Jun. 30, 2016

(54) METHODS AND SYSTEMS FOR DISPLAYING DATA

(71) Applicant: Zappoint Corporation, Taipei City (TW)

(72) Inventors: John C. Wang, Taipei City (TW); Hsi-Tsun Chien, Taipei City (TW); Yuan-Chang Fan, Taipei City (TW)

(21) Appl. No.: 14/977,732

(22) Filed: Dec. 22, 2015

(30) Foreign Application Priority Data
Dec. 31, 2014 (TW) 103146455

(51) Int. Cl. H04N 5/232; G06T 7/00

(52) U.S. Cl. CPC H04N 5/23293; G06T 7/004; H04N 5/23229; G06T 2207/30244; G06T 2207/10016

(57) ABSTRACT

Methods and systems for displaying data for use in an electronic device are provided. First, an image corresponding to at least one specific object is captured by an image capture unit. When the distance between the electronic device and the specific object has changed or the presentation manner of the specific object in the display unit has changed, first data is displayed via the display unit.

### BACKGROUND OF THE INVENTION

1. Field of the Invention

The disclosure relates generally to methods and systems for displaying data, and, more particularly to methods and systems that can determine how to display different data according to at least one image captured by an image capture unit.

2. Description of the Related Art

Recently, electronic devices, such as smart phones, notebooks, wearable devices or other portable devices, have become more and more technically advanced and multifunctional. For example, portable devices have network connectivity capabilities. Users can use their portable devices to connect to networks at anytime and anywhere. The convenience and new functionalities advanced by modern technology have made these devices into necessities of life.

On the other hand, an AR (Augmented Reality) technology has been widely used in applications for environment navigation, commercial purposes, as well as other fields. AR is a way to observe the real environment by integrating environment entities and a VR (Virtual Reality) technology. AR technology can use an image recognition technology to detect and track physical objects within images, and use a 3D technology to combine and display physical objects with preset virtual objects via a screen.

Generally, users can obtain information, such as additional data corresponding to physical objects which is not provided in the real environment via AR technology. Currently, the information displayed in a virtual object is typically fixed. In other words, no matter how users observe the virtual object, only the information which has been preset for the virtual object can be provided to the users. Consequently, there exists an opportunity to enrich the AR experience by providing various and flexible information by virtual objects. This can greatly expand the applicability of AR technology.

### BRIEF SUMMARY OF THE INVENTION

Methods and systems for displaying data are provided, in which different data can be displayed based on at least one image captured by an image capture unit.

In an embodiment of a method for displaying data, an image corresponding to at least a specific object is captured by an image capture unit of an electronic device. Then, it is determined whether the distance between the electronic device and the specific object has changed. When the distance between the electronic device and the specific object is changed, first data is displayed via a display unit of the electronic device.

An embodiment of a system for displaying data comprises a storage unit, an image capture unit, a display unit, and a processing unit. The storage unit contains first data. The image capture unit captures an image corresponding to at least one specific object. The processing unit determines whether the distance between the electronic device and the specific object has changed. When the distance between the electronic device and the specific object has changed, the processing unit displays the first data via the display unit.

In some embodiments, it is determined whether the specific object in the image is a predefined object. When the specific object in the image is the predefined object, second data is displayed via the display unit of the electronic device. In some embodiments, the second data comprises at least one virtual object. When the distance between the electronic device and the specific object has changed, the first data is displayed in the virtual object. In some embodiments, specific data is first displayed in the virtual object, and the specific data is replaced by the first data when the distance between the electronic device and the specific object has changed, such that the first data is displayed in the virtual object. The first data comprises detail contents for the specific data.

In some embodiments, a second image is captured by the image capture unit of the electronic device. The determination of whether the distance between the electronic device and the specific object has changed is performed according to the respective size of the specific object in the image and the second image.

In some embodiments, movement information corresponding to the electronic device is detected by a motion sensor of the electronic device. The determination of whether the distance between the electronic device and the specific object has changed is performed according to the movement information.

In some embodiments, the electronic device has a sensing unit for detecting the distance between the electronic device and the specific object.

In an embodiment of a method for displaying data, an image corresponding to at least a specific object is captured by an image capture unit of an electronic device. The image is displayed via a display unit of the electronic device. Then, it is determined whether the presentation manner of the specific object in the display unit has changed. When the presentation manner of the specific object in the display unit has changed, first data is displayed via the display unit of the electronic device.

An embodiment of a system for displaying data comprises a storage unit, an image capture unit, a display unit, and a processing unit. The storage unit contains first data. The image capture unit captures an image corresponding to at least one specific object. The image is displayed via the display unit. The processing unit determines whether the presentation manner of the specific object in the display unit has changed. When the presentation manner of the specific object in the display unit has changed, the processing unit displays the first data via the display unit.

In some embodiments, a second image is captured by the image capture unit of the electronic device. The determination of whether the presentation manner of the specific object in the display unit has changed is performed according to the image and the second image.

In some embodiments, movement information corresponding to the electronic device is detected by a motion sensor of the electronic device. The determination of whether the presentation manner of the specific object in the display unit has changed is performed according to the movement information.

In some embodiments, the distance between the electronic device and the specific object is detected. The determination of whether the presentation manner of the specific object in the display unit has changed is performed according to the distance between the electronic device and the specific object.

In some embodiments, the determination of whether the presentation manner of the specific object in the display unit has changed is performed by determining whether a zoom-in command or a zoom-out command is received by the electronic device.

In some embodiments, the presentation manner comprises the size, shape and/or position of the specific object displayed in the display unit.

Methods for displaying data may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed descriptions with references to the accompanying drawings, wherein:

FIG. 1 is a schematic diagram illustrating an embodiment of a system for displaying data of the invention;

FIG. 2 is a flowchart of an embodiment of a method for displaying data of the invention;

FIG. 3 is a flowchart of another embodiment of a method for displaying data of the invention;

FIG. 4 is a schematic diagram illustrating an example of a specific object of the invention;

FIGS. 5A and 5B are schematic diagrams illustrating an example of data display of the invention;

FIG. 6 is a flowchart of another embodiment of a method for displaying data of the invention; and

FIG. 7 is a flowchart of another embodiment of a method for displaying data of the invention.

### DETAILED DESCRIPTION OF THE INVENTION

Systems and methods for displaying data are provided.

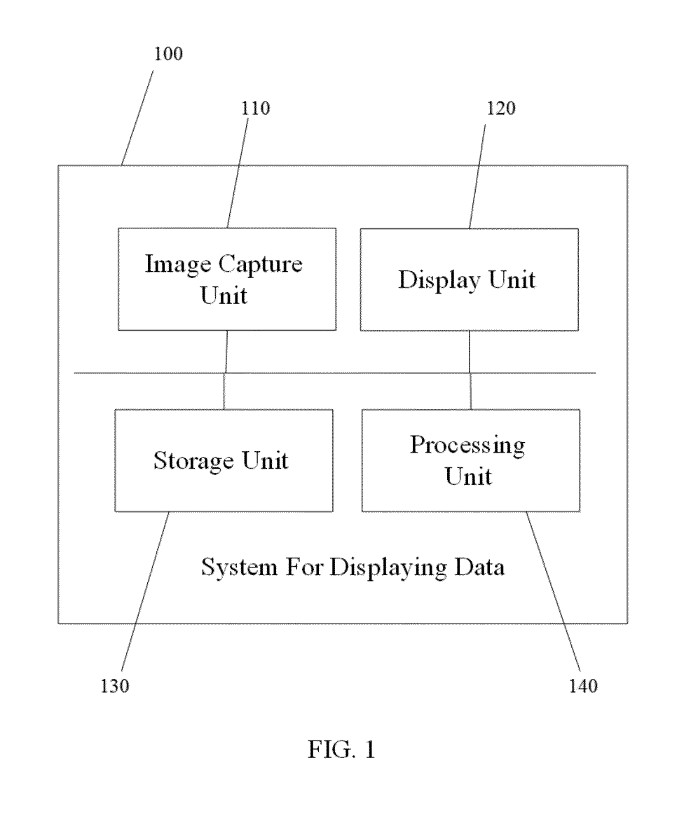

FIG. 1 is a schematic diagram illustrating an embodiment of a system for displaying data of the invention. The system for displaying data can be used in an electronic device, such as a computer, or a portable device, such as a mobile phone, a smart phone, a PDA (Personal Digital Assistant), a GPS (Global Positioning System), a camera or a tablet.

The system for displaying data 100 comprises an image capture unit 110, a display unit 120, a storage unit 130, and a processing unit 140. The image capture unit 110 can perform an image capture process to obtain at least one image. The display unit 120 can display related information, such as the image captured by the image capture unit 110, interfaces, and/or data. The storage unit 130 stores the image captured by the image capture unit 110, and/or related data, such as user interfaces and data corresponding to at least one virtual object. The processing unit 140 can control related operations of hardware and software in the electronic device, and perform the methods for displaying data, which will be discussed later.

It is understood that, in some embodiments, the system for displaying data 100 can have a network connecting unit (not shown in FIG. 1) for connecting to a network, such as a wired network, a telecommunication network, and/or a wireless network. The system for displaying data 100 can have network connectivity capabilities by using the network connecting unit. In some embodiments, the virtual object in the storage unit 130 can be obtained from a server via a network. On the other hand, in some embodiments, the system for displaying data 100 can have AR technology, thus it can display the image captured by the image capture unit 110 and the virtual object via the display unit 120 in real-time.

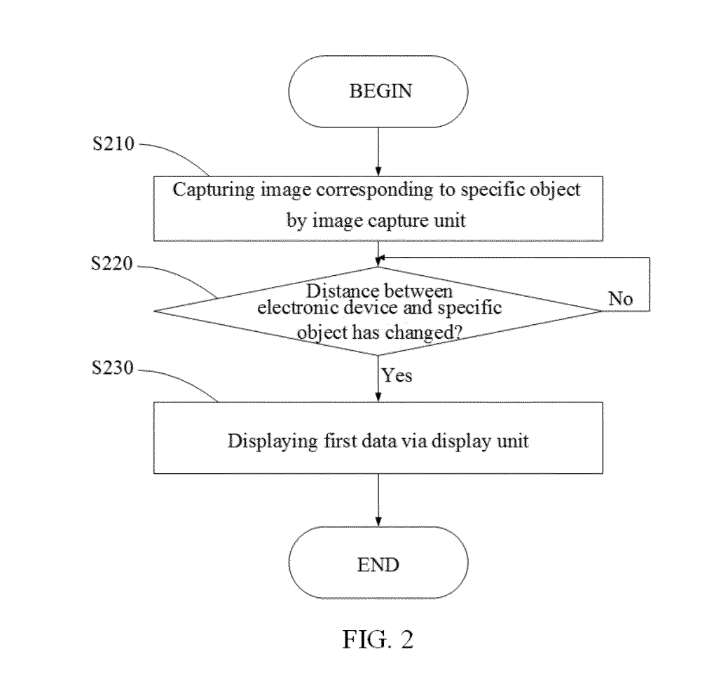

FIG. 2 is a flowchart of an embodiment of a method for displaying data of the invention. The method for displaying data can be used in an electronic device, such as a computer, or a portable device, such as a mobile phone, a smart phone, a PDA, a GPS, a camera or a tablet.

In step S210, an image corresponding to at least one specific object is captured by an image capture unit of the electronic device. Then, in step S220, it is determined whether the distance between the electronic device and the specific object has changed. It is understood that, in some embodiments, another image can be later captured via the image capture unit of the electronic device. The determination of whether the distance between the electronic device and the specific object has changed is performed according to the respective size of the specific object in the two images. For example, when the size of the specific object becomes larger, it is determined that the distance between the electronic device and the specific object has changed. Specifically, it is determined that the electronic device is closer to the specific object. In some embodiments, movement information corresponding to the electronic device can be detected by a motion sensor, such as an accelerometer and/or a Gyro sensor of the electronic device. The determination of whether the distance between the electronic device and the specific object has changed is performed according to the movement information. For example, when the electronic device moves toward to the view direction, it is determined that the distance between the electronic device and the specific object has changed. Specifically, it is determined that the electronic device is closer to the specific object. In some embodiments, the electronic device has a sensing unit, such as a laser rangefinder for detecting the distance between the electronic device and the specific object. The determination of whether the distance between the electronic device and the specific object has changed is performed according to the distance between the electronic device and the specific object. It is noted that, the above methods for determining whether the distance between the electronic device and the specific object has changed are only examples of the present application, and the present invention is not limited thereto. When the distance between the electronic device and the specific object has not changed (No in step S220), the procedure remains at step S220. When the distance between the electronic device and the specific object has changed (Yes in step S220), in step S230, first data is displayed via a display unit of the electronic device. It is understood that, in some embodiments, only when the distance between the electronic device and the specific object becomes closer, step S230 is performed.

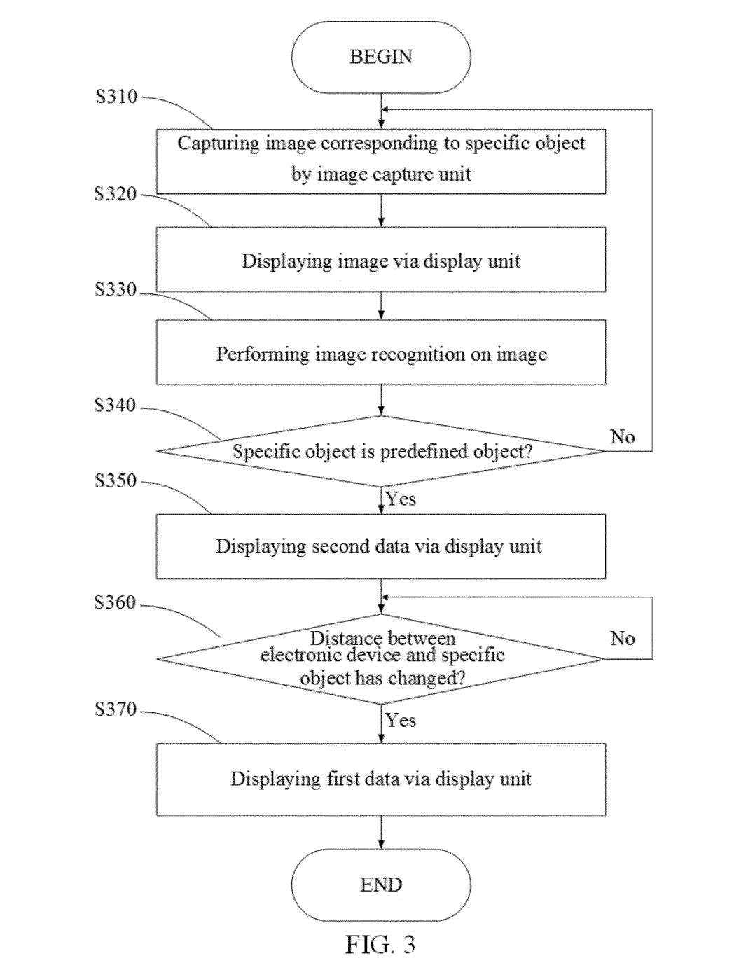

FIG. 3 is a flowchart of another embodiment of a method for displaying data of the invention. The method for displaying data can be used in an electronic device, such as a computer, or a portable device, such as a mobile phone, a smart phone, a PDA, a GPS, a camera or a tablet.

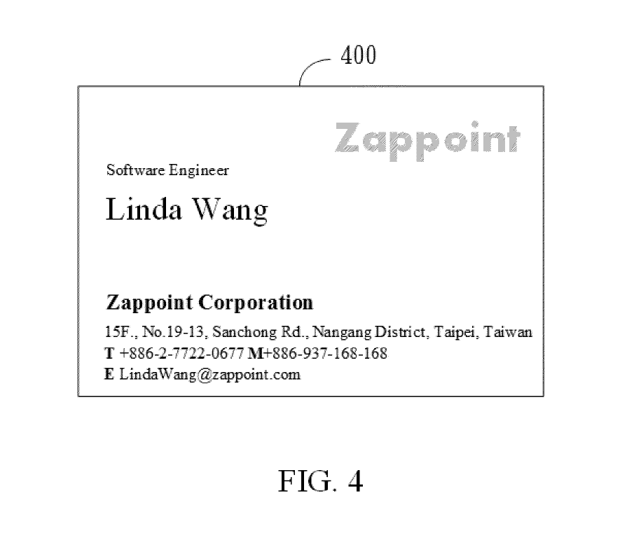

In step S310, an image corresponding to at least one specific object is captured by an image capture unit of the electronic device. Then, in step S320, the captured image is displayed via a display unit of the electronic device. In step S330, the image is analyzed with an image recognition process, and in step S340, it is determined whether the specific object in the image is a predefined object. It is understood that, in some embodiments, when the specific object comprises a specific text, a specific number, and/or a specific symbol, it is determined that the specific object is the predefined object. In some embodiments, when the specific object has a specific shape, such as a circle, triangle or rectangle, it is determined that the specific object is the predefined object. In some embodiments, the predefined object may be a business card 400 with a rectangle shape, as shown in FIG. 4. When the specific object is not the predefined object (No in step S340), the procedure goes to step S310. When the specific object is the predefined object (Yes in step S340), in step S350, second data is displayed via the display unit of the electronic device. It is understood that, in some embodiments, the second data comprises at least one virtual object. It is noted that, the virtual object can be generated using an image processing technology, and the virtual object can be displayed in the display unit. It is noted that, in some embodiments, specific data can be displayed in the virtual object. Then, in step S360, it is determined whether the distance between the electronic device and the specific object has changed. Similarly, in some embodiments, another image can be later captured via the image capture unit of the electronic device. The determination of whether the distance between the electronic device and the specific object has changed is performed according to the respective size of the specific object in the two images. In some embodiments, movement information corresponding to the electronic device can be detected by a motion sensor, such as an accelerometer and/or a Gyro sensor of the electronic device. The determination of whether the distance between the electronic device and the specific object has changed is performed according to the movement information. In some embodiments, the electronic device has a sensing unit for detecting the distance between the electronic device and the specific object. The determination of whether the distance between the electronic device and the specific object has changed is performed according to the distance between the electronic device and the specific object. It is noted that, the above methods for determining whether the distance between the electronic device and the specific object has changed are only examples of the present application, and the present invention is not limited thereto. When the distance between the electronic device and the specific object has not changed (No in step S360), the procedure remains at step S360. When the distance between the electronic device and the specific object has changed (Yes in step S360), in step S370, first data is displayed via a display unit of the electronic device. Similarly, in some embodiments, only when the distance between the electronic device and the specific object becomes closer, step S370 is performed. It is noted that, in some embodiments, the first data comprises detail contents for the specific data. In some embodiments, specific data is first displayed in the virtual object, and the specific data is replaced by the first data when the distance between the electronic device and the specific object has changed, such that the first data is displayed in the virtual object.

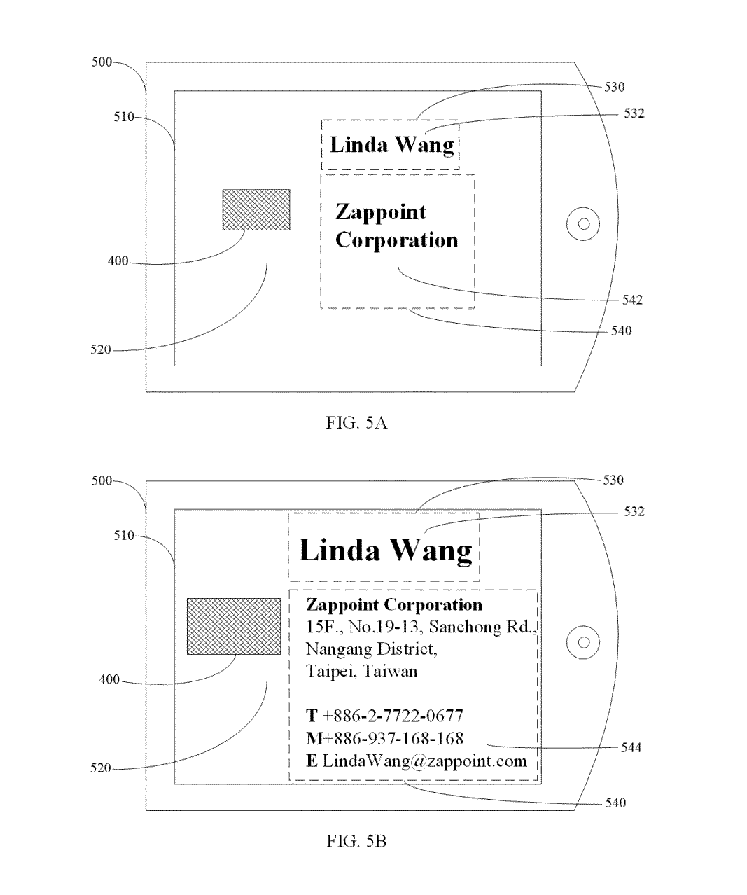

FIGS. 5A and 5B are schematic diagrams illustrating an example of data display of the invention. A user can use an image capture unit of an electronic device 500, such as a smartphone to capture an image 520 corresponding to a specific object, such as the business card 400 in FIG. 4. It is noted that, a display unit 510 of the electronic device 500 can display the image 520 comprising the business card 400. The image 520 can be analyzed with an image recognition process. When the business card 400 is a predefined object, the electronic device 500 can use AR technology to display virtual objects 530 and 540 via the display unit 510, and respectively display data 532 and 542 in the virtual objects 530 and 540, as shown in FIG. 5A. It is understood that, the data 532 and/or 542 may correspond to the business card 400. In some embodiments, the data 532 and/or 542 can be downloaded from a server via a network, and associated with the business card 400. When the distance between the electronic device 500 and the business card 400 is changed, for example, when the user holds the electronic device 500 closer to the business card 400, the data 542 in the virtual object 540 can be replaced by data 544, as shown in FIG. 5B.

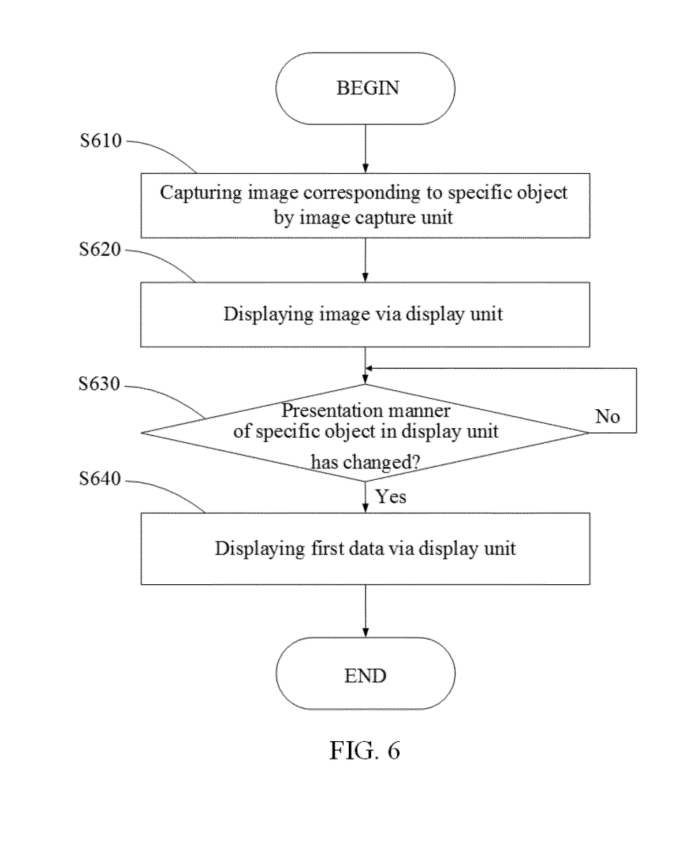

FIG. 6 is a flowchart of another embodiment of a method for displaying data of the invention. The method for displaying data can be used in an electronic device, such as a computer, or a portable device, such as a mobile phone, a smart phone, a PDA, a GPS, a camera or a tablet.

In step S610, an image corresponding to at least one specific object is captured by an image capture unit of the electronic device. Then, in step S620, the captured image is displayed via a display unit of the electronic device. In step S630, it is determined whether the presentation manner of the specific object in the display unit is changed. It is noted that, the presentation manner comprises the size, shape and/or position of the specific object displayed in the display unit. It is understood that, in some embodiments, another image can be further captured via the image capture unit of the electronic device. The determination of whether the presentation manner of the specific object in the display unit is changed is performed according to the two images. In some embodiments, the determination of whether the presentation manner of the specific object in the display unit is changed is performed by determining whether a zoom-in command or a zoom-out command is received by the electronic device. In some embodiments, movement information corresponding to the electronic device can be detected by a motion sensor of the electronic device. The determination of whether the presentation manner of the specific object in the display unit has changed is performed according to the movement information. In some embodiments, the electronic device has a sensing unit for detecting the distance between the electronic device and the specific object. The determination of whether the presentation manner of the specific object in the display unit has changed is performed according to the distance between the electronic device and the specific object. It is noted that, the above methods for determining whether the presentation manner of the specific object in the display unit has changed are only examples of the present application, and the present invention is not limited thereto. When the presentation manner of the specific object in the display unit has not changed (No in step S630), the procedure remains at step S630. When the presentation manner of the specific object in the display unit has changed (Yes in step S630), in step S640, first data is displayed via a display unit of the electronic device. It is understood that, in some embodiments, only when the specific object is magnified to be viewed in the display unit, step S640 is performed.

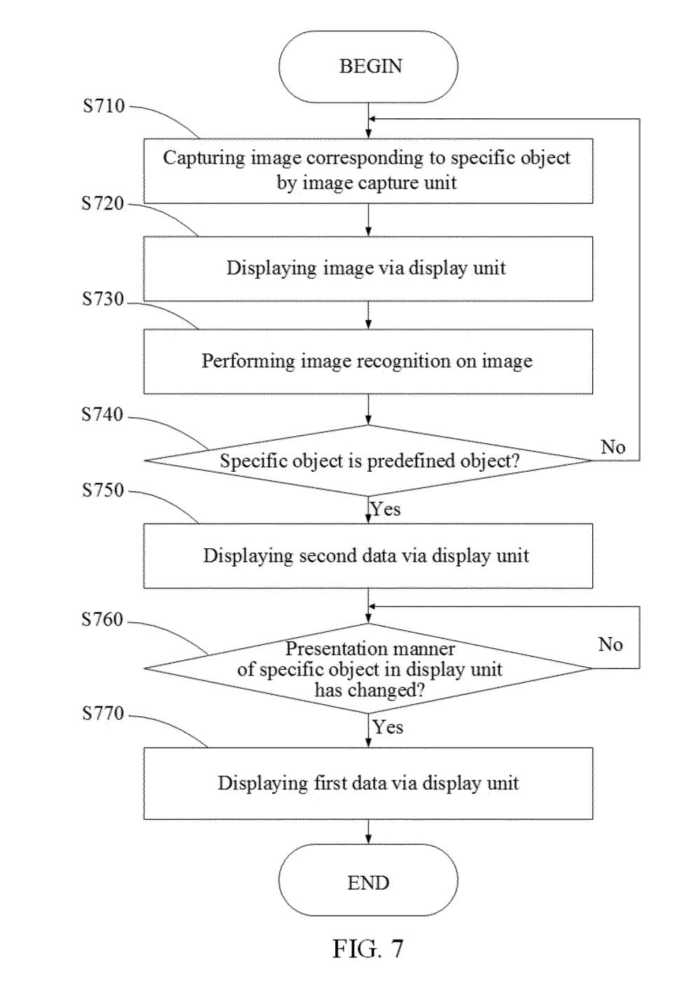

FIG. 7 is a flowchart of another embodiment of a method for displaying data of the invention. The method for displaying data can be used in an electronic device, such as a computer, or a portable device, such as a mobile phone, a smart phone, a PDA, a GPS, a camera or a tablet.

In step S710, an image corresponding to at least one specific object is captured by an image capture unit of the electronic device. Then, in step S720, the captured image is displayed via a display unit of the electronic device. In step S730, the image is performed with an image recognition process, and in step S740, it is determined whether the specific object in the image is a predefined object. It is understood that, in some embodiments, when the specific object comprises a specific text, a specific number, and/or a specific symbol, it is determined that the specific object is the predefined object. In some embodiments, when the specific object has a specific shape, such as a circle, triangle or rectangle, it is determined that the specific object is the predefined object. When the specific object is not the predefined object (No in step S740), the procedure goes to step S710. When the specific object is the predefined object (Yes in step S740), in step S750, second data is displayed via the display unit of the electronic device. It is understood that, in some embodiments, the second data comprises at least one virtual object. It is noted that, the virtual object can be generated using an image processing technology, and the virtual object can be displayed in the display unit. It is noted that, in some embodiments, specific data can be displayed in the virtual object. Then, in step S760, it is determined whether the presentation manner of the specific object in the display unit has changed. Similarly, the presentation manner comprises the size, shape and/or position of the specific object displayed in the display unit. Similarly, in some embodiments, another image can be further captured via the image capture unit of the electronic device. The determination of whether the presentation manner of the specific object in the display unit is changed is performed according to the two images. In some embodiments, the determination of whether the presentation manner of the specific object in the display unit has changed is performed by determining whether a zoom-in command or a zoom-out command is received by the electronic device. In some embodiments, movement information corresponding to the electronic device can be detected by a motion sensor of the electronic device. The determination of whether the presentation manner of the specific object in the display unit has changed is performed according to the movement information. In some embodiments, the electronic device has a sensing unit for detecting the distance between the electronic device and the specific object. The determination of whether the presentation manner of the specific object in the display unit has changed is performed according to the distance between the electronic device and the specific object. It is noted that, the above methods for determining whether the presentation manner of the specific object in the display unit has changed are only examples of the present application, and the present invention is not limited thereto. When the presentation manner of the specific object in the display unit has not changed (No in step S760), the procedure remains at step S760. When the presentation manner of the specific object in the display unit has changed (Yes in step S760), in step S770, first data is displayed via a display unit of the electronic device. Similarly, in some embodiments, only when the specific object is magnified to be viewed in the display unit, step S770 is performed. It is noted that, in some embodiments, the first data may comprise detail contents for the specific data. In some embodiments, specific data is first displayed in the virtual object, and the specific data is replaced by the first data when the presentation manner of the specific object in the display unit is changed, such that the first data is displayed in the virtual object.

Therefore, the methods and systems for displaying data of the present invention can determine how to display different data according to at least one image captured by an image capture unit, thereby providing better user experiences and increasing the applicability of VR and/or AR technologies.

Methods for displaying data may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A method for displaying data for use in an electronic device, comprising:
capturing an image corresponding to at least one specific object by an image capture unit of the electronic device;
determining whether the distance between the electronic device and the specific object has changed; and
when the distance between the electronic device and the specific object has changed, displaying first data via a display unit of the electronic device.

2. The method of claim 1, further comprising:
displaying the image in the display unit of the electronic device;
determining whether the specific object in the image is a predefined object; and
when the specific object in the image is the predefined object, displaying second data via the display unit of the electronic device.

3. The method of claim 2, wherein the second data comprises at least one virtual object, and when the distance between the electronic device and the specific object has changed, the first data is displayed in the virtual object.

4. The method of claim 3, further comprising:
first displaying specific data in the virtual object; and
replacing the specific data by the first data when the distance between the electronic device and the specific object has changed, such that the first data is displayed in the virtual object, wherein the first data comprises detail contents for the specific data.

5. The method of claim 4, further comprising capturing a second image by the image capture unit of the electronic device, wherein the determination of whether the distance between the electronic device and the specific object has changed is performed according to the respective size of the specific object in the image and the second image.

6. The method of claim 1, further comprising detecting movement information corresponding to the electronic device by a motion sensor of the electronic device, wherein the determination of whether the presentation manner of the specific object in the display unit has changed is performed according to the movement information.

7. The method of claim 1, wherein the electronic device comprises a sensing unit for detecting the distance between the electronic device and the specific object.

8. A method for displaying data for use in an electronic device, comprising:
capturing an image corresponding to at least a specific object by an image capture unit of the electronic device;
displaying the image via a display unit of the electronic device;
determining whether the presentation manner of the specific object in the display unit has changed; and
when the presentation manner of the specific object in the display unit has changed, displaying first data via the display unit of the electronic device.

9. The method of claim 8, wherein the determination of whether the presentation manner of the specific object in the display unit is changed is performed by determining whether a zoom-in command or a zoom-out command is received by the electronic device.

10. A system for displaying data for use in an electronic device, comprising:
a storage unit comprising first data;
an image capture unit capturing an image corresponding to at least a specific object;
a display unit; and
a processing unit determining whether the distance between the electronic device and the specific object is changed, and displaying first data via the display unit when the distance between the electronic device and the specific object has changed.

11. A system for displaying data for use in an electronic device, comprising:
a storage unit comprising first data;
an image capture unit capturing an image corresponding to at least one specific object;
a display unit displaying the image; and
a processing unit determining whether the presentation manner of the specific object in the display unit has changed, and displaying first data via the display unit when the presentation manner of the specific object in the display unit has changed.

12. A machine-readable storage medium comprising a computer program, which, when executed, causes a device to perform a method for displaying data, wherein the method comprises:
capturing an image corresponding to at least one specific object by an image capture unit of an electronic device;
determining whether the distance between the electronic device and the specific object has changed; and
when the distance between the electronic device and the specific object has changed, displaying first data via a display unit of the electronic device.

13. A machine-readable storage medium comprising a computer program, which, when executed, causes a device to perform a method for displaying data, wherein the method comprises:
capturing an image corresponding to at least one specific object by an image capture unit of an electronic device;
displaying the image via a display unit of the electronic device;
determining whether the presentation manner of the specific object in the display unit has changed; and
when the presentation manner of the specific object in the display unit has changed, displaying first data via the display unit.
